(19) United States
(12) Patent Application Publication
(10) Pub. No.: US 2021/0065056 A1
(43) Pub. Date: Mar. 4, 2021

(54) PARAMETER CALCULATING DEVICE, PARAMETER CALCULATING METHOD, AND RECORDING MEDIUM HAVING PARAMETER CALCULATING PROGRAM RECORDED THEREON

(71) Applicant: NEC CORPORATION, Tokyo (JP)

(72) Inventor: Takuya HIRAOKA, Tokyo (JP)

(73) Assignee: NEC CORPORATION, Tokyo (JP)

(21) Appl. No.: 16/961,121

(22) PCT Filed: Jan. 10, 2018
(86) PCT No.: PCT/JP2018/000261

§ 371 Date: Jul. 9, 2020

(51) Int. Cl. G06N 20/00

(52) U.S. Cl. CPC G06N 20/00; G05B 2219/40499; G05B 2219/32334

(57) ABSTRACT

Provided is a parameter calculating device that takes human prior knowledge into account. The parameter calculating device according to the present invention is provided with: an identifying means that identifies intermediate states from a certain state to a target state and rewards concerning the intermediate states on the basis of a plurality of states concerning a target system, associated information by which two states among the plurality of states are associated with each other, rewords concerning at least some of the states, model information including parameters representing the states of the target system, and given ranges concerning the parameters; and a parameter calculating means that calculates the values of the parameters in the case where the identified rewards and the degrees of the differences between the values of the parameters and the given ranges satisfy predetermined conditions.

### TECHNICAL FIELD

The present invention relates to a parameter calculating device and, more particularly, to a parameter calculating device in a hierarchical planner.

### BACKGROUND ART

Reinforcement Learning is a kind of machine learning and deals with a problem in which an agent in an environment observes a current state and determines actions to be carried out. The agent gets a reward from the environment by selecting the actions. The reinforcement learning learns a policy such that the maximum reward is obtained through a series of actions. The environment is also called a controlled target or a target system.

In the reinforcement learning in a complicated environment, a huge amount of calculation time required in learning tends to become a large bottleneck. As one of variations of the reinforcement learning for resolving such a problem, there is a framework called a “hierarchical reinforcement learning” in which the learning is improved in efficiency by preliminarily limiting, using a different model, a range to be searched and by performing the learning in such limited search space by a reinforcement learning agent. A model for limiting the search space is called a high-level planner whereas a reinforcement learning model for performing the learning in the search space presented by the high-level planner is called a low-level planner. A combination of the high-level planner and the low-level planner is called a hierarchical planner. A combination of the low-level planner and the environment is also called a simulator.

For example, Non-Patent Literature 1 proposes a “Hierarchical Reinforcement Learning” which comprises two reinforcement learning agents consisting of a Meta-Controller and a Controller. In a situation where there are a plurality of intermediate states from a staring state to an objective state (Goal), is supposed a case where it is desired to reach the objective state (target stage) via a shortest route from the starting state. Herein, each intermediate state is also called a Subgoal. In Non-Patent Literature 1, the Meta-Controller presents, to the Controller, a subgoal to be reached next among a plurality of preliminarily given subgoals (however, each of which is mentioned as a “goal” in Non-Patent Literature 1).

The Meta-Controller is also called the above-mentioned high-level planner whereas the Controller is also called the above-mentioned low-level planner. Accordingly, in Non-Patent Literature 1, the high-level planner determines a specific subgoal among the plurality of subgoals whereas the low-level planner determines an actual action for the environment on the basis of the specific subgoal.

The high-level planner generates a plan with a symbolic representation in knowledge. For instance, it is assumed that the environment is a tank. In this event, the high-level planner plans, for example, to lower a temperature of the tank when the temperature in the tank is high.

In comparison with this, the simulator performs simulation using a continuous quantity in the real world. Thus, the simulator cannot understand what the high temperature is, to what degree the temperature is lowered, and so on. In other words, the simulator cannot perform the simulation unless the symbolic representation is associated with a numeric representation (continuous amount). Such association between the symbolic representation (right and left, high and low, or the like) in the knowledge and the continuous quantity (a position of an object, a control threshold, or the like) in the simulator is called symbol grounding functions (symbol grounding problem) in this technical field. That is, the symbol grounding problem is a problem how symbols get their meanings in a relationship with the real world.

The above-mentioned symbol grounding functions have two kinds consisting of a first symbol grounding function and a second symbol grounding function. The first symbol grounding function is provided between the environment and the high-level planner. On the other hand, the second symbol grounding function is provided between the high-level planner and the low-level planner. For instance, it is assumed that environment is the tank. In this event, the first symbol grounding function is a function which is supplied with the numeric representation (continuous quantity) being the temperature of the tank and associates (converts) the numeric representation with (into) the symbolic representation of “high temperature” when the temperature (continuous amount) is not less than XX° C. The second symbol grounding function is a function for associating (converting) the symbolic representation “to lower the temperature of the tank” supplied from the high-level planner with (into) the numeric representation (continuous amount) to lower the temperature to YY° C. or less.

Non-Patent Literatures 2 and 3 describe examples of the hierarchical planner for performing such symbol grounding that relate to the present invention. As will later be described with reference to the drawings, in these related arts, a parameter for the hierarchical planner is optimized based solely on an interaction history.

### CITATION LIST

### Non-Patent Literatures

NPL 1: Tejas D. Kulkarni, et al. “Hierarchical Deep Reinforcement Learning: Integrating Tmporal Abstraction and Intrinsic Motivation.” 30th Conference on Nural Information Processing Systems (NIPS 2016), Barcelona, Spein.
NPL 2: George Konidaris, et al. “Constructing Symbolic Representations for High-Level Planning.” AAAI. 2014.
NPL 3: George Konidaris, et al. “Symbol acquisition for probabilistic high-level planning.” AAAI, 2015.
NPL 4: Sutton, Richard S, et al. “Between MDPs and semi-MDPs: A framework for temporal abstraction in reinforcement learning.” Artificial Intelligence 112. 1-2 (1999): 1811-211
NPL 5: Williams, Ronald J. “Simple statistical gradient-following algorithms for connectionist reinforcement learning. “Machine learning 8.3-4 (1992): 229-256.

### SUMMARY OF THE INVENTION

### Technical Problem

The problem in the above-mentioned related arts is that, in the related arts, human beings cannot easily understand an operation of each module after optimization in the hierarchical planner for performing the symbol grounding. This is because, in the related arts, the parameter for the hierarchical planner is optimized based on only the interaction history.

### OBJECT OF INVENTION

It is an object of the present invention to provide a parameter calculating device which is capable of resolving the above-mentioned problem.

### Solution to Problem

As an aspect of the present invention, a parameter calculating device comprises an identifying means configured to identify an intermediate state from a certain state to a target state and a reward concerned with the intermediate state based on a plurality of states concerned with a target system, associated information in which two states among the plurality of states are associated with each other, a reward concerned with at least some of the states, model information including a parameter indicative of a state of the target system, and a given range concerned with the parameter; and a parameter calculating means configured to calculate a value of the parameter in a case where the identified reward and a degree of a difference between the value of the parameter and the given range satisfy a predetermined condition.

### Advantageous Effects of Invention

The present invention has an effect that human beings can easily understand an operation of each module after optimization.

### BRIEF DESCRIPTION OF THE DRAWINGS

FIG. 1 is a block diagram for illustrating a configuration of a control system including a hierarchical planner for performing symbol grounding in a related art;

FIG. 2 is a block diagram for illustrating an internal configuration of a high-level planner for use in the hierarchical planner of FIG. 1;

FIG. 3 is a block diagram for illustrating a configuration of a control system including a hierarchical planner for performing symbol grounding according to an example embodiment of the present invention;

FIG. 4 is a block diagram for illustrating an internal configuration of a high-level planner for use in the hierarchical planner of FIG. 3;

FIG. 5 is a block diagram for illustrating a configuration of a first symbol grounding function parameter updating unit in FIG. 4;

FIG. 6 is a block diagram for illustrating a configuration of a second symbol grounding function parameter updating unit in FIG. 4;

FIG. 7 is a flow chart for use in describing an operation of the hierarchical planner according to the example embodiment of the present invention;

FIG. 8 is a view for illustrating a dynamic Bayesian network for high-level planning and a grounding process which are used in an example of the present invention;

FIG. 9 is a view for illustrating a Mountain Car task which is used in the example of the present invention;

FIG. 10 is a view for illustrating an example of “carrying out an interaction between a hierarchical planner and an environment to accumulate an interaction history” in FIG. 7;

FIG. 11 is a view for illustrating an example of symbol knowledge for the high-level planner illustrated in FIG. 4;

FIG. 12 is a view for illustrating an example of prior knowledge recorded in a knowledge recording medium 60 illustrated in FIG. 4;

FIG. 13 is a view for illustrating REINFORCE Algorithms proposed in Non-Patent Literature 5;

FIG. 14 is a view for illustrating a parameter updating method for the hierarchical planner, which is proposed in this example;

FIG. 15 is a view for illustrating an example of policy which is implemented based on a Gaussian distribution having a position of a car as a stochastic variable in this example;

FIG. 16 is a view for illustrating averages and standard deviations, which are obtained from the prior knowledge illustrated in FIG. 12; and

FIG. 17 is a view for illustrating comparison of updated parameters between the related art and the example of the present invention.

### DESCRIPTION OF EMBODIMENTS

### Related Art

In order to facilitate an understanding of the present invention, a related art will be described first.

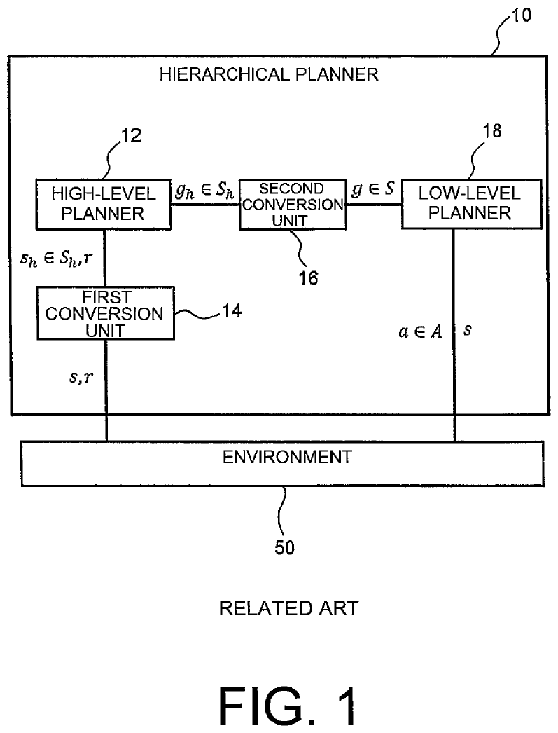

FIG. 1 is a block diagram for illustrating a configuration of a control system including a hierarchical planner for performing symbol grounding in the related art. As shown in FIG. 1, the control system of the related art comprises the hierarchical planner 10 and an environment 50. The environment 50 is also called a controlled target or a target system.

The hierarchical planner 10 comprises a high-level planner 12, a first conversion unit 14, a second conversion unit 16, and a low-level planner 18.

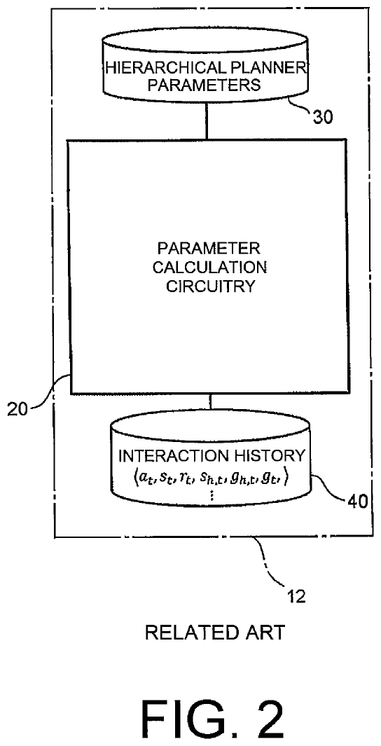

FIG. 2 is a block diagram for illustrating an internal configuration of the high-level planner 12 for use in the hierarchical planner 10 of FIG. 1. The high-level planner 12 comprises a parameter calculation circuitry 20, a parameter storage unit 30 for storing hierarchical planner parameters, and a history recording medium 40 for recording an interaction history.

The control system of the related art having such a configuration operates as follows.

The environment 50 receives an action a, and produces numeric state information s belonging to a state set S and a reward r. Herein, the numeric state information s is a continuous quantity representing a state of the environment 50 with a numeric representation.

The first conversion unit 14 receives the numeric state information s, the reward r, and first symbol grounding parameters, and produces, based on a first symbol grounding function, a state symbol sₕ belonging to a state symbol set Sₕ and the reward r. Herein, the state symbol sₕ is a symbol represented by a symbolic representation in knowledge. The first conversion unit 14 is also called a low-level/high-level conversion unit.

The high-level planner 12 receives the state symbol sₕ, the reward r, and high-level planner parameters, and produces a subgoal symbol gₕ belonging to the state symbol set Sₕ. Herein, the subgoal symbol gₕ is a symbol indicative of an intermediate state represented by the symbolic representation in the knowledge. In this specification, the subgoal symbol gₕ may simply be also called an “intermediate state”. In addition, a starting state, an objective state (target state), and the intermediate state may simply be called “states” collectively.

The second conversion unit 16 receives the subgoal symbol gₕ and second symbol grounding parameters, and produces, based on a second symbol grounding function, a subgoal g belonging to the state set S. Herein, the subgoal g comprises numeric information indicative of the intermediate state. The second conversion unit 16 may also be called a high-level/low-level conversion unit.

In the related art, as the first symbol grounding function and the second symbol grounding function, functions that are manually and carefully designed beforehand are used.

The low-level planner 18 receives the numeric state information s, the subgoal g, and low-level planner parameters, and produces the action a belonging to an action set A.

It is assumed that a series of these steps is one process. Then, the history recording medium 40 receives, for every one process, the numeric state information s, the reward r, the subgoal symbol gₕ, the subgoal g, and the action a, and records them as the interaction history.

The parameter calculation circuitry 20 receives, from the history recording medium 40, the numeric state information s, the reward r, the subgoal symbol gₕ, the sugoal g, and the action a, which are saved as the interaction history, and updates parameters for the hierarchical planner 10 to produce updated parameters.

The parameter storage unit 30 receives the updated parameters from the parameter calculation circuitry 20, saves them as the hierarchical planner parameters, and outputs the saved hierarchical planner parameters in response to a readout request.

As described above, the problem in the above-mentioned related art is that, in the related art, human beings cannot easily understand operations of respective modules after optimization (i.e. the first conversion unit 14, the high-level planner 12, the second conversion unit 16, and the low-level planner 18) in the hierarchical planner 10 for performing the symbol grounding. This is because, in the related art, the hierarchical planner parameters are optimized based on only the interaction history.

### Example Embodiment

An example embodiment of the present invention will hereinafter be described in detail with reference to the drawings.

[Explanation of Configuration]

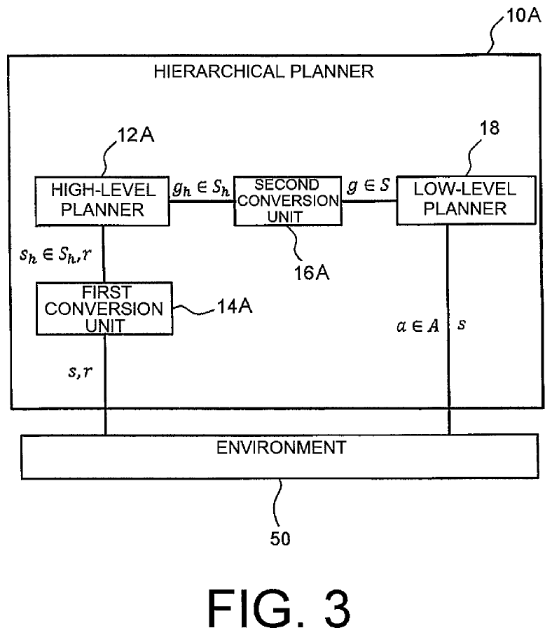

FIG. 3 is a block diagram for illustrating a configuration of a control system including a hierarchical planner for performing symbol grounding according to an example embodiment of the present invention. As shown in FIG. 3, the control system according to the example embodiment comprises a hierarchical planner 10A and the environment 50. The environment 50 is also called a controlled target or a target system.

The hierarchical planner 10A comprises a high-level planner 12A, a first conversion unit 14A, a second conversion unit 16A, and the low-level planner 18.

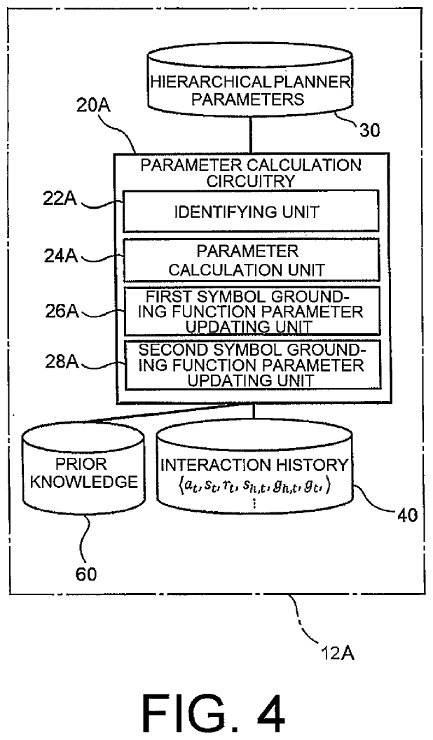

FIG. 4 is a block diagram for illustrating an internal configuration of the high-level planner 12A for use in the hierarchical planner 10A of FIG. 3. The high-level planner 12A comprises a parameter calculation circuitry 20A, the parameter storage unit 30 for storing the hierarchical planner parameters, the history recording medium 40 for recording the interaction history, and a knowledge recording medium 60 for recording prior knowledge.

The parameter calculation circuitry 20A comprises an identifying unit 22A, a parameter calculation unit 24A, a first symbol grounding function parameter updating unit 26A, and a second symbol grounding function parameter updating unit 28A.

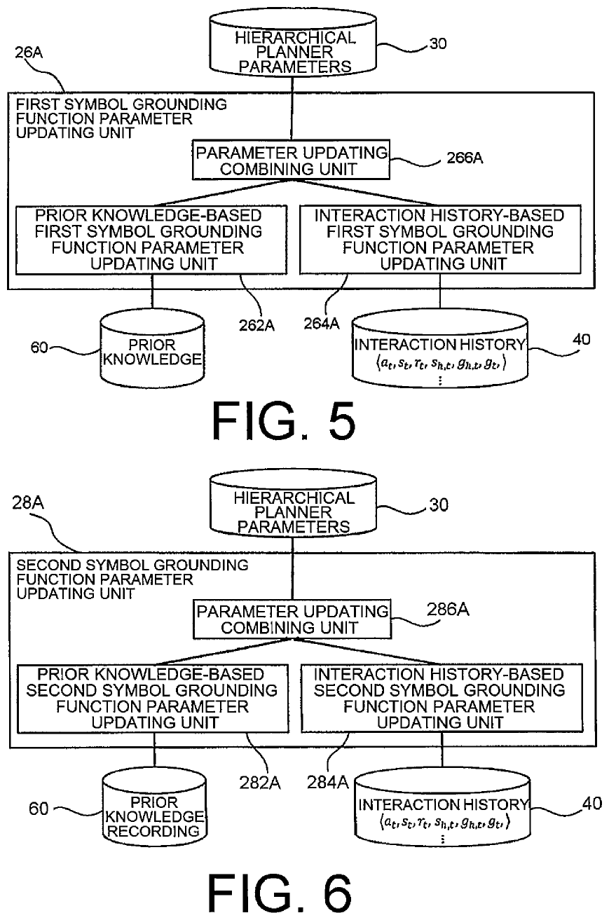

Referring to FIG. 5, the first symbol grounding function parameter updating unit 26A comprises a prior knowledge-based first symbol grounding function parameter updating unit 262A, an interaction history-based first symbol grounding function parameter updating unit 264A, and a parameter updating combining unit 266A.

Referring to FIG. 6, the second symbol grounding function parameter updating unit 28A comprises a prior knowledge-based second symbol grounding function parameter updating unit 282A, an interaction history-based second symbol grounding function parameter updating unit 282A, and a parameter updating combining unit 286A.

These means operate as follows, respectively.

The environment 50 receives an action a, and produces numeric state information s belonging to a state set S and a reward r.

The first conversion unit 14A receives the numeric state information s, the reward r, and first symbol grounding function parameters with prior knowledge which will later be described, and produces, based on a first symbol grounding function, a state symbol sₕ belonging to the state symbol set Sₕ and the reward r. Herein, the first symbol grounding function is first association information indicative of association between the numeric state information and a state corresponding to the numeric state information. Accordingly, the first conversion unit 14A calculates, based on the first association information, the state corresponding to the numeric state information.

The high-level planner 12A receives the state symbol sₕ, the reward r, and high-level planner parameters with prior knowledge, and produces a subgoal symbol gₕ belonging to the state symbol set Sₕ.

The second conversion unit 16A receives the subgoal symbol gₕ and the first symbol grounding function parameters with prior knowledge which will later be described, and produces, based on a second symbol grounding function, a subgoal g belonging to the state set S. Herein, the second symbol grounding function is second association information indicative of association between the state and the numeric information corresponding to the state. Accordingly, the second conversion unit 16 calculates, based on the second association information, numeric information indicative of the above-mentioned intermediate state.

The low-level planner 18 receives the numeric state information s, the subgoal g, and low-level planner parameters with prior knowledge, and produces the action a belonging to an action set A. In other words, the low-level planner 18 prepares, based on a difference between the numeric information indicative of the intermediate state and observation information which is observed with respect to the target system 50, control information for controlling the target system 50. Specifically, the low-level planner 18 may be, for example, a controller for carrying out PID (proportional integral and differential) control.

It is assumed that a series of these steps is one process. Then, the history recording medium 40 receives, for every one process, the numeric state information s, the reward r, the subgoal symbol gₕ, the subgoal g, and the action a, and records them as an interaction history.

The parameter calculation circuitry 20A receives prior knowledge from the knowledge recording medium 60, receives, from the history recording medium 40, the numeric information s, the reward r, the subgoal symbol gₕ, the subgoal g, and the action a, which are saved as the interaction history, and updates parameters for the hierarchical planner 10A to produce updated hierarchical planner parameters.

The identifying unit 22A identifies, based on a plurality of states concerned with the target system 50, associated information in which two states among the plurality of states are associated with each other, a reward concerned with at least some of the states, model information including a parameter indicative of a state of the target system 50, and a given range concerned with the parameter, an intermediate state (subgoal symbol) from a certain state to a target state (final object) and a reward concerned with the intermediate state. Herein, the associated information in which the two states among the plurality of states are associated with each other is high-level planner symbol knowledge. The model information including the parameter is, for example, a normal distribution.

The parameter calculation unit 24A calculates a value of the parameter in a case where the identified reward and a degree of a difference between the value of the parameter and the above-mentioned given range satisfy a predetermined condition. Herein, the predetermined condition is supposed to be, for example, a condition that a differential value is the largest in a case where a steepest descent is adopted as an optimization method.

As shown in FIG. 5, in the first symbol grounding function parameter updating unit 26A, the prior knowledge-based first symbol grounding function parameter updating unit 262A receives the prior knowledge from the knowledge recording medium 60 and produces a first parameter updated signal of the first symbol grounding function parameters with prior knowledge. The interaction history-based first symbol grounding function parameter updating unit 264A receives the interaction history from the history recording medium 40 and produces a second parameter updated signal of first symbol grounding function parameters with prior knowledge. The parameter updating combining unit 266A receives the first parameter updated signal and the second parameter updated signal, and combines these signals to produce combined first symbol grounding function parameters with prior knowledge.

As shown in FIG. 6, the second symbol grounding function parameter updating unit 28A carries out an operation similar to that of the first symbol grounding function parameter updating unit 26A. Specifically, the prior knowledge-based second symbol grounding function parameter updating unit 282A receives the prior knowledge from the knowledge recording medium 60 and produces a third parameter updated signal of the second symbol grounding function parameters with prior knowledge. The interaction history-based first symbol grounding function parameter updating unit 284A receives the interaction history from the history recording medium 40 and produces a fourth parameter updated signal of second symbol grounding function parameters with prior knowledge. The parameter updating combining unit 286A receives the third parameter updated signal and the fourth parameter updated signal, and combines these signals to produce combined second symbol grounding function parameters with prior knowledge.

As described above, each of the first symbol grounding function parameter updating unit 26A and the second symbol grounding function parameter updating unit 28A updates the association information (symbol grounding function) based on the values of the calculated parameters. In other words, the first symbol grounding function parameter updating unit 26A and the second symbol grounding function parameter updating unit 28A update the first and the second association information (first and second symbol grounding functions) by using the above-mentioned calculated parameters as parameters of the first and the second association information (first and second grounding functions), respectively.

The parameter storage unit 30 receives the parameters with prior knowledge from the parameter calculation circuitry 20A and saves them as the hierarchical planner parameters.

These means mutually operate so as repeat 1) accumulation of the interaction history using the hierarchical planner 10 and 2) parameter updating using the accumulated interaction history and the prior knowledge. It is therefore possible to obtain an effect that the hierarchical planner 10 can be optimized in consideration of both of the prior knowledge and the interaction history.

[Explanation of Operation]

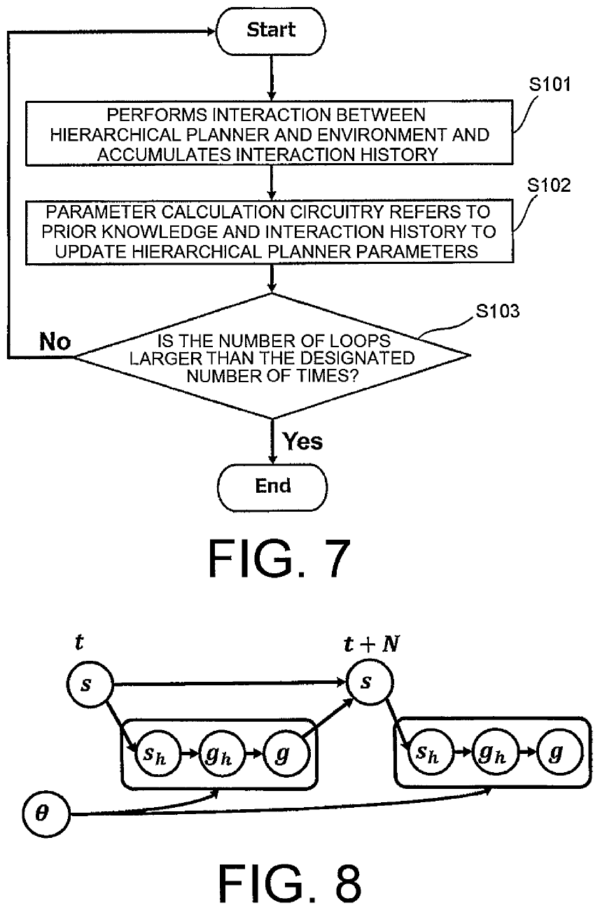

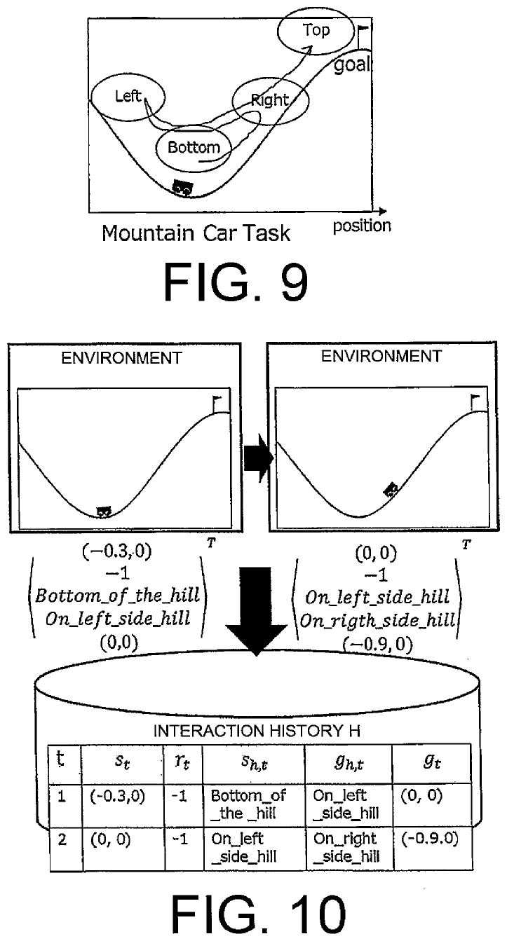

Next, referring to a flow chart of FIG. 7, description will proceed to an operation of the overall control system including the hierarchical planner 10 according to the example embodiment.

First, the control system carries out interaction between the hierarchical planner 10 and the environment 50 to accumulate the interaction history (Step S101). The interaction history is recorded in the history recording medium 40.

Next, the parameter calculation circuitry 20A updates the hierarchical planner parameters by referring to the prior knowledge recorded in the knowledge recording medium 60 and the interaction history recorded in the history recording medium 40 (Step S102). The updated hierarchical planner parameters are stored in the parameter storage unit 30.

The control system repeats these steps by a designated number of times (Step S103).

[Explanation of Effect]

Next, an effect of the example embodiment will be described.

The example embodiment is configured to repeat 1) accumulation of the interaction history between the hierarchical planner 10 and the environment 50 and 2) parameter updating using the accumulated interaction history and the prior knowledge. It is therefore possible to optimize the hierarchical planner parameters in consideration of both of the prior knowledge and the interaction history.

Each part of the hierarchical planner 10A may be implemented by a combination of hardware and software. In a form in which the hardware and the software are combined, the respective parts are implemented as various kinds of means by developing a parameter calculating program in a RAM (random access memory) and making hardware such as a control unit (CPU (central processing unit)) operate based on the parameter calculating program. The parameter calculating program may be recorded in a recording medium to be distributed. The parameter calculation program recorded in the recording medium is read into a memory via a wire, wirelessly, or via the recording medium itself to operate the control unit and so on. By way of example, the recording medium may be an optical disc, a magnetic disk, a semiconductor memory device, a hard disk, or the like.

Explaining the above-mentioned example embodiment with a different expression, it is possible to implement the example embodiment by making a computer to be operated as the hierarchical planner 10A act as the parameter calculation circuitry 20A (the identifying unit 22A, the parameter calculation unit 24A, the first symbol grounding function parameter updating unit 26A, and the second symbol grounding function parameter updating unit 28A) according to the parameter calculating program developed in the RAM.

### Example

Next, description will proceed to an operation of the mode for embodying the present invention using a specific example.

This example supposes semi-Markov decision processes (SMDPs) described in Non-Patent Literature 4. FIG. 8 illustrates a dynamic Bayesian network for high-level planning and a grounding process. The dynamic Bayesian network illustrated in FIG. 8 shows that a state transition is decided by an interaction result between the low-level planner 18 and the environment 50 after the high-level planner 12A supplies the subgoal g through the second conversion unit 16A to the low-level planner 18. The interaction result is saved in the history recording medium 40 as the interaction history. In FIG. 8, θ is a parameter.

This example supposes a “Mountain Car” task. In the Mountain Car task, a torque is applied to a car to make the car arrive at a goal on a hill. In this task, the reward r is 100 if the car arrives at the goal, and is −1 otherwise. The state set S includes a velocity of the car and a position of the car. Accordingly, the numeric state information s and the subgoal g belong to the state set S. The action set A includes the torque of the car. The action a belongs to the action set A. The state symbol set Sₕ is {Bottom_of_hills, On_right_side_hill, On_left_side_hill, At_top_of_right_side_hill}. The state symbol sₕ and the subgoal symbol gₕ belong to the state symbol set Sₕ. In this example, [Bottom_of_hills] indicates the starting state. [At_top_of_right_side_hill] indicates the objective state (target state). [On_right_side_hill] and [On_left_side_hill] indicate the intermediate states. In this example, the environment 50 comprises an operating simulator of the car present in the hill. In addition, in this example, the hierarchical planner 10A plans a way how to apply the torque of the car based on the position and the velocity of the car. In FIG. 10, at every unit time interval, the interaction result between the environment 50 and the hierarchical planner 10A is saved in the history recording medium 40 as the interaction history.

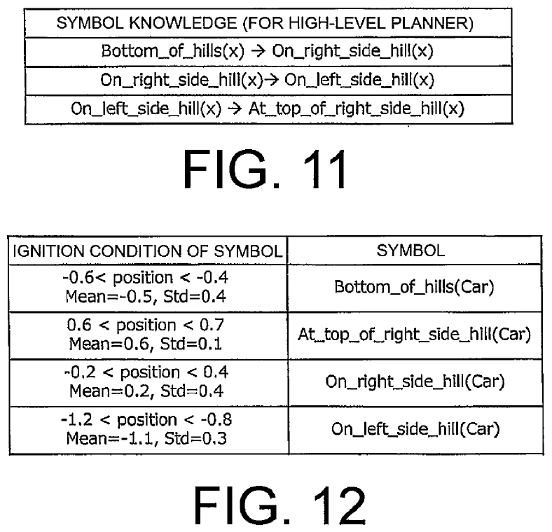

The high-level planner 12A in this example is a Strips-style planner based on symbol knowledge. FIG. 11 illustrates an example of the symbol knowledge for the high-level planner 12A. The symbol knowledge for the high-level planner 12A illustrated in FIG. 11 is the associated information in which two states among the plurality of sates are associated with each other. On the other hand, the low-level planner 18 in this example is implemented by model predictive control.

Furthermore, in this example, the prior knowledge recorded in the knowledge recording medium 60 is constructed based on the symbol grounding functions which are prepared by manpower. FIG. 12 illustrates an example of the prior knowledge constructed based on the symbol grounding functions prepared by the manpower.

In FIG. 12, a combination of an average Mean and a standard deviation Std in an “ignition condition of symbol” shows the above-mentioned parameter θ. Accordingly, values of the average Mean and the standard deviation Std in the “ignition condition of symbol” represent the model information (normal distribution) including the parameter θ indicative of the states of the target system 50. As will later be described in detail, the parameter θ is learned and changed by reinforcement learning with constraints which will later be described. In FIG. 12, ranges of the positions in the “ignition condition of symbol” indicate given ranges concerned with the parameter θ.

Next, description will proceed to a method of learning the symbol grounding functions using the reinforcement learning with constraints according to this example.

In the reinforcement learning with constraints, as illustrated in the following numerical expression:

$${arg max}_{θ} {E}_{{π}_{θ}} [ {\sum }_{t = 0} {r}_{t} ] \qquad [ Math . 1 ]$$

the parameter θ in policy π(gₜ, gₕ, sₕ, θ|s) of the high-level planning including the symbol grounding functions with prior knowledge is learned so that E_{πθ}[Σₜ=₀rₜ] becomes the maximum. The policy π(gₜ, gₕ, sₕ, θ|s) is represented by the following numerical expression:

π(g,gₕ,sₕ,θ|s):=πₛ_{ₕ}_{→s}(g|gₕ,θ)P(gₕ|sₕ)π_{s→s}_{ₕ}(sₕ|s,θ)P(θ) [Math. 2]

where P(θ) represents the prior knowledge. In the expression of Math. 2, the first symbol grounding function is represented by:

π_{s→s}_{ₕ} [Math. 3]

The second symbol grounding function is represented by:

πₛ_{ₕ}_{→s} [Math. 4]

The high-level planner 12A is represented by P(gₕ|sₕ).

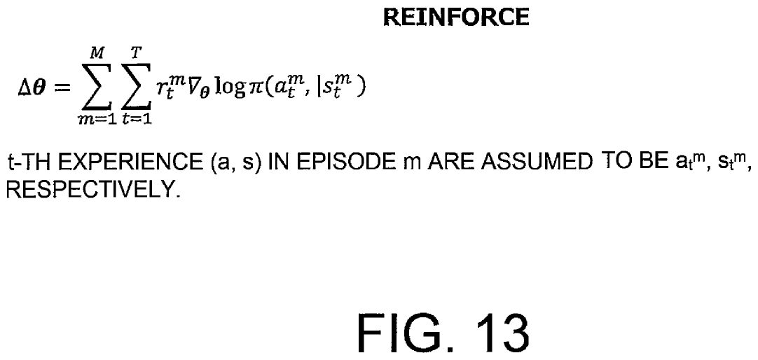

Non-Patent Literature 5 proposes REINFORCE Algorithms as illustrated in FIG. 13.

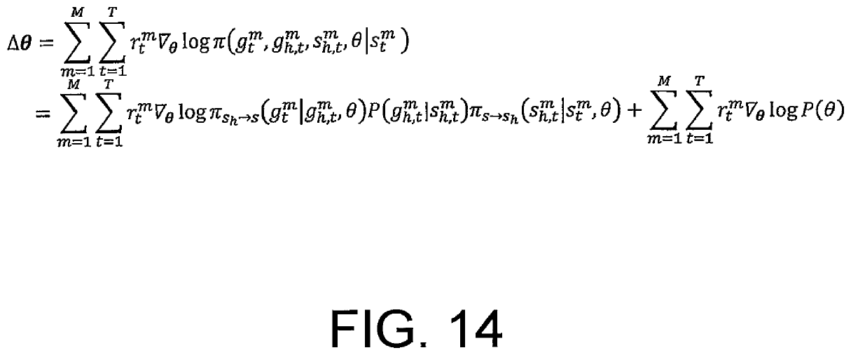

In comparison with this, this example proposes a parameter updating method for the hierarchical planner 10A as illustrated in FIG. 14. In the expression of FIG. 14, a first term of the right side is a term for updating the parameter θ based on the interaction history and is obtained by modifying the REINFORCE Algorithms illustrated in FIG. 13. On the other hand, a second term of the right side in the expression of FIG. 14 indicates a constraint term for updating the parameter θ based on the prior knowledge. Accordingly, the updating expression of AO illustrated in FIG. 14 is an updating expression obtained by applying, regarding a function weighted with constraint conditions related to the reward r and the parameter θ, the optimization method such as the steepest descent or the like.

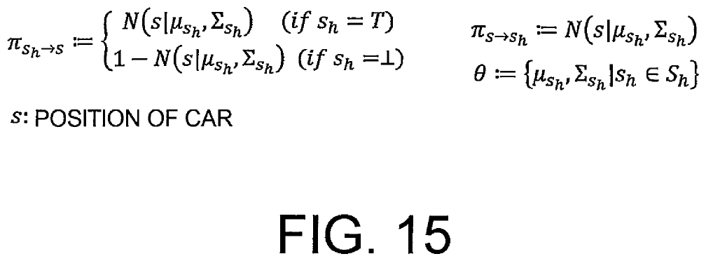

In this example, as illustrated in FIG. 15, the policy π(gₜ, gₕ, sₕ, θ|s) is implemented based on the Gaussian distribution with the position of the car used as a stochastic variable.

Accordingly, in this example, the parameters in the first symbol grounding function and the second symbol grounding function are calculated in accordance with the common parameter θ through optimization.

As illustrated in FIG. 15, in this example, the first symbol grounding function and the second symbol grounding function are represented by the Gaussian distribution:

N(s|μₛ_{ₕ},Σₛ_{ₕ}) [Math. 5]

The average:

μₛ_{ₕ} [Math. 6]

and the standard deviation:

Σₛ_{ₕ} [Math. 7]

are used as the parameter θ to be optimized.

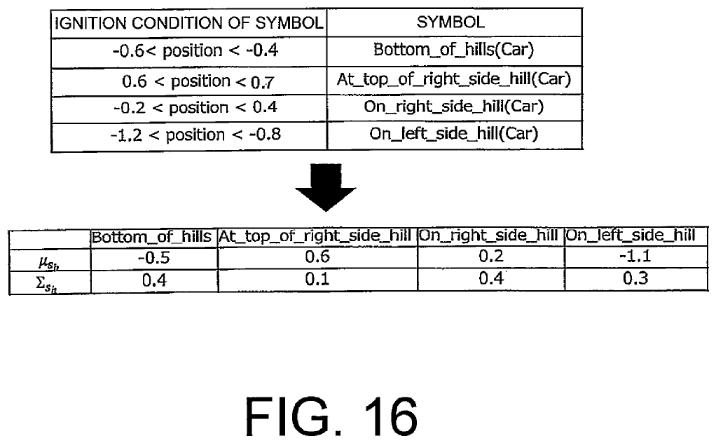

FIG. 16 is a view for illustrating the above-mentioned averages and the above-mentioned standard deviations, which are obtained from the prior knowledge illustrated in FIG. 12.

In this example, the parameter calculation circuitry 20A carries out optimization by referring to the prior knowledge concerned with these parameters. For instance, the parameter calculation circuitry 20A refers to the prior knowledge that, corresponding to:

└sₕ=At_top_of_right_side_hill┘ [Math. 8]

the average and the standard deviation

μₛ_{ₕ},Σₛ_{ₕ} [Math. 9]

are “0.6” and “0.1”, respectively.

In this example, the interaction history-based first symbol grounding function parameter updating unit 264A uses modifications of the REINFORCE Algorithms disclosed in the above-mentioned Non-Patent Literature 5 (see, the first term of the right side in the expression in FIG. 14).

In this example, the prior knowledge-based first symbol grounding function parameter updating unit 262A and the prior knowledge-based second symbol grounding function parameter updating unit 282A update the parameter so as to bring the parameter closer to that defined by the prior knowledge (see, the second term of the right side in the expression in FIG. 14). The parameter updating combining units 266A and 286A are implemented by adding both of the updated ones.

The present inventor experimentally evaluated, on the basis of these methods, how easily the operations of the respective modules are interpretable actually for human beings in a case (Proposed) of learning optimization of the parameter θ in consideration of the prior knowledge in comparison with a case (Baseline) without consideration of the prior knowledge.

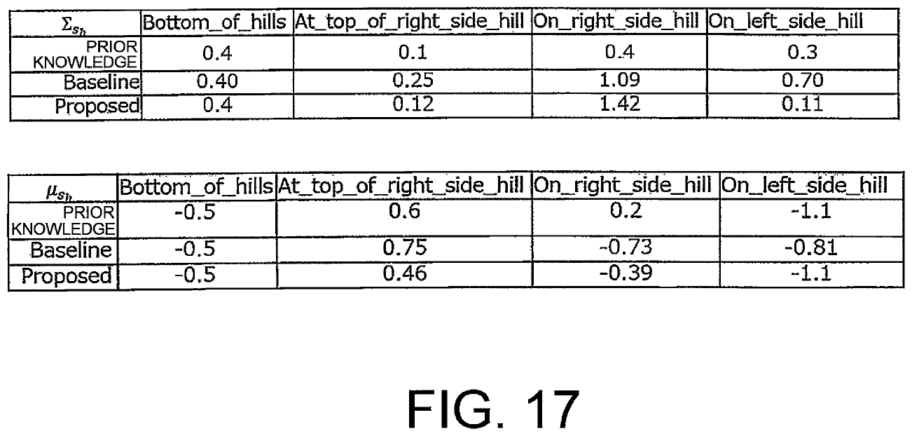

FIG. 17 is a view for illustrating the parameters which are obtained by learning. In FIG. 17, the upper table indicates the averages whereas the lower table indicates the standard deviations. At the top in the tables, each column represents a symbol whereas elements in the tables represent a likely position (−1.8, 0.9) of the car in the environment 50.

In the Baseline, the average of “Bottom_of_hills” is “−0.5” whereas the average of “On_right_side_hill” is “−0.73”. This suggests that the “right-side bottom” exists on the left side than the “bottom between left-side and right-side hills” and leads to a result which is incomprehensible for human beings. On the other hand, in the Proposed no such problem occurs.

A specific configuration of the present invention is not limited to the afore-mentioned example embodiment. Alterations without departing from gist of the present invention are included in the present invention.

While the invention has been particularly shown and described with reference to the example embodiment (example) thereof, the invention is not limited to the above-mentioned example embodiment (example). It will be understood by those of ordinary skill in the art that various changes in form and details may be made therein without departing from the sprit and scope of the present invention as defined by the claims.

### INDUSTRIAL APPLICABILITY

The present invention is applicable to uses such as a plant operation support system. In addition, the present invention is also applicable to uses such as an infrastructure operating support system.

### REFERENCE SIGNS LIST

50 environment (target system)
10, 10A hierarchical planner
14, 14A first conversion unit
12, 12A high-level planner
16, 16A second conversion unit
18 low-level planner
20, 20A parameter calculation circuitry
22A identifying unit
24A parameter calculation unit
26A first symbol grounding function parameter updating unit
28A second symbol grounding function parameter updating unit
262A prior knowledge-based first symbol grounding function parameter updating unit
264A interaction history-based first symbol grounding function parameter updating unit
266A parameter updating combining unit
282A prior knowledge-based second symbol grounding function parameter updating unit
284A interaction history-based second symbol grounding function parameter updating unit
286A parameter updating combining unit
40 history recording medium
60 knowledge recording medium
30 parameter storage unit

1. A parameter calculating device, comprising:
an identifying unit configured to identify an intermediate state from a certain state to a target state and a reward concerned with the intermediate state based on a plurality of states concerned with a target system, associated information in which two states among the plurality of states are associated with each other, a reward concerned with at least some of the states, model information including a parameter indicative of a state of the target system, and a given range concerned with the parameter; and
a parameter calculating unit configured to calculate a value of the parameter in a case where the identified reward and a degree of a difference between the value of the parameter and the given range satisfy a predetermined condition.

2. The parameter calculating device as claimed in claim 1, comprising a conversion unit configured to calculate the intermediate state or numeric information indicative of the intermediate state based on association information indicative of association between the states and numeric information indicative of the states.

3. The parameter calculating device as claimed in claim 2, comprising a low-level planner configured to prepare control information for controlling the target system based on a difference between the numeric information indicative of the intermediate state and observation information observed with respect to the target system.

4. The parameter calculating device as claimed in claim 1, comprising an updating means configured to update the associated information based on the calculated value of the parameter.

5. The parameter calculating device as claimed in claim 2, wherein the association information includes a first symbol grounding function for associating the numeric information with the state.

6. The parameter calculating device as claimed in claim 2, wherein the association information includes a second symbol grounding function for associating the state with the numeric information.

7. A parameter calculating method in an information processing device, the method comprising:
identifying an intermediate state from a certain state to a target state and a reward concerned with the intermediate state based on a plurality of states concerned with a target system, associated information in which two states among the plurality of states are associated with each other, a reward concerned with at least some of the states, model information including a parameter indicative of a state of the target system, and a given range concerned with the parameter; and
calculating a value of the parameter in a case where the identified reward and a degree of a difference between the value of the parameter and the given range satisfy a predetermined condition.

8. The parameter calculating method as claimed in claim 7, the method comprising:
calculating the intermediate state or numeric information indicative of the intermediate state based on association information indicative of association between the states and numeric information indicative of the states.

9. The parameter calculating method as claimed in claim 8, the method comprising:
preparing control information for controlling the target system based on a difference between the numeric information indicative of the intermediate state and observation information observed with respect to the target system.

10. A non-transitory recoding medium recording a parameter calculating program causing a computer to execute:
an identifying step of identifying an intermediate state from a certain state to a target state and a reward concerned with the intermediate state based on a plurality of states concerned with a target system, associated information in which two states among the plurality of states are associated with each other, a reward concerned with at least some of the states, model information including a parameter indicative of a state of the target system, and a given range concerned with the parameter; and
a parameter calculating step of calculating a value of the parameter in a case where the identified reward and a degree of a difference between the value of the parameter and the given range satisfy a predetermined condition.
